(19) United States
(12) Patent Application Publication
(10) Pub. No.: US 2006/0271481 A1
(43) Pub. Date: Nov. 30, 2006

(54) Systems and methods for making conditional purchase requests

(76) Inventor: Perry Chen, Brooklyn, NY (US)

Correspondence Address: Daniel H. Golub;Morgan, Lewis & Bockius LLP, 1701 Market Street, Philadelphia, PA, 19103-2921, US

(21) Appl. No.: 11/501,427

(22) Filed: Aug. 9, 2006

Related U.S. Application Data
(63) Continuation-in-part of application No. 10/946,521, filed on Sep. 20, 2004.
(60) Provisional application No. 60/577,280, filed on Jun. 4, 2004.

(51) Int. Cl. G06Q 40/00

(52) U.S. Cl. 705/40; 705/35

(57) ABSTRACT

Methods and systems for making a conditional sale of content or a novelty item online, or conducting a fundraising event online.

### CROSS-REFERENCE TO RELATED APPLICATIONS

The present application is a continuation-in-part of U.S. patent application Ser. No. 10/946,521, filed Sep. 20, 2004, entitled “Method and System for Making a Conditional Event Binding on Purchasers and Vendors,” which claims the benefit of U.S. Provisional Patent Application No. 60/577,280, filed Jun. 4, 2004. The content of these earlier applications is incorporated herein by reference.

### FIELD OF THE INVENTION

The present invention relates to methods and systems for making a conditional sale of content or a novelty item online, or conducting a fundraising event online.

### BACKGROUND OF THE INVENTION

Traditionally, the production of an event can require significant expense and risk. An event, such as a concert, requires the vendor, usually the event promoter, to coordinate venues, talent, promotions, advertising and other related event planning services. Usually, the vendor incurs significant expense in covering this overhead and accepts an amount of risk in return for the potential profit from the event. It is not uncommon for events to fail to generate revenue sufficient to cover the expenses and compensate for the work and financial risk of the vendor. Sometimes, in anticipation of insufficient revenue, vendors will choose to “cut their losses” by canceling an event and refunding the event purchase price to ticket holders. In either case, the outcome is unsatisfactory to the vendor.

Similarly, the performance of an achievement, such as designing a new product, requires the product development company to coordinate personnel, resources, market research and other research and development and related product services. Again, as in the case of the concert promoter, the company incurs significant risk and expense, and it is not uncommon for the new product to generate insufficient revenue or the development process to be terminated prematurely due to the anticipation of insufficient revenue.

Under this traditional system, many events and achievements are considered too risky or cumbersome to attempt. Inevitably, it is probable that a potentially successful event or achievement will not be attempted because of the risk inherent in this traditional system that the event or achievement will not be profitable.

Due to the emergence of the Internet, the traditional system of product purchasing and the market experience of vendors and buyers have vastly changed. The benefits of the Internet for vendors include the increase in the amount of available buyers, and the decrease of many traditional overhead expenses. In turn, potential buyers have access to more vendors and more products and are able to shop 24 hours a day. Additionally, the rise of e-commerce has brought with it many new and exciting ways for vendors and buyers to do business.

The use of the Internet has also been established to create efficiencies in relation to the billing and payment for the purchase of goods and services. The widespread use of credit and debit cards and other online credit and debit services has allowed remote online transactions to flourish with added speed and security. In many instances such transactions are instantaneous, as vendors communicate with the credit institutions over communications networks to verify a buyer's identity and credit worthiness, and to have a buyer's charges approved or rejected in relation to the purchase of products or services.

Another feature of credit card transactions commonly used is for the vendor to perform an “authorize only” transaction. In such a transaction the amount is not charged to the buyer at the time of authorization but rather the buyer's credit card company authorizes the future charge of a specific amount of funds. This authorization guarantees payment to the vendor from the credit card company if, and when, such a charge is submitted. This method is widely used by car rental companies and hotels as an alternative to requiring a cash deposit.

Thus, there is a need to supplement the traditional event and achievement production system with a dynamic system that minimizes vendor risk by providing that the sale of the event or achievement shall become binding on the buyer and the vendor only upon the satisfaction of some pre-defined criteria specified by the vendor. Such a system would utilize the benefits of “authorize-only” credit card transactions to ensure efficiency and guarantee payment to the vendor upon satisfaction of the pre-defined criteria. Such a system would also allow vendors to offer a broader variety of events and achievements to the public by creating an environment where events or achievements that were previously too risky or too cumbersome for a vendor to consider producing can now be offered at limited risk to the vendor.

“Behind-the-Scenes” content has been widely used to supplement or promote a main product (usually a film or television show) as a promotional tool, as included bonus material with a DVD or VHS purchase, or as additional products themselves for those with extended interest in a television show or film.

Thus, in many cases, it is commercially beneficial to supplement the sale of an event or achievement with content related to production or development activities for the event or achievement. This content can serve to entertain and/or inform the buyer. In most cases this content can best be delivered over the internet or digital cable; or otherwise digitally delivered.

Frequently, the development and production of an event or achievement takes a significant amount of time. Feature-length films and music albums can take months or years to be developed, produced, and prepared for digital or physical delivery. Any extended waiting period between the purchase and delivery of product can serve as a deterrent to potential buyers. Thus, buyers may hesitate to purchase events or achievements that will not be delivered in the immediate future.

Thus, in many cases, there is the need to supplement the sale of an event or achievement with content related to production or development activities for the event or achievement. This content can serve to entertain and/or inform the buyer, and also further provides a solution to the problem of buyers waiting extended dormant periods for the delivery of an event or achievement.

### SUMMARY OF THE INVENTION

The present application is directed to a method and system for making a conditional sale of content online, wherein the content conveys information related to production or development activities for an event, product or service. A network site accessible over a communication network from remote computers is provided. Pre-defined criteria are received from a vendor of the content. The pre-defined criteria must be satisfied before the vendor is obligated to cause the content to be produced. The pre-defined criteria include an aggregate threshold volume of conditional purchases that must be made by a plurality of different buyers for at least one of the content, event, product or service.

Commercial terms relating to making a conditional purchase for at least one of the content, event, product or service, are displayed to the buyers over the network site. The commercial terms include one or more vendor-defined prices associated with the conditional purchase. The content is identified to the buyers over the network site. An agreement is received from the vendor to make the content available to each buyer in exchange for the conditional purchase during a time period following satisfaction of the pre-defined criteria and during the production or development activities (which commence after satisfaction of the pre-defined criteria.) Conditional purchase requests for at least one of the content, event, product or service, are received from the plurality of buyers over the network site. Each of the conditional purchase requests includes credit or debit account information from a buyer and specifies a conditional purchase amount that includes at least one of the vendor-defined prices. In response to each conditional purchase request, an authorize-only credit or debit transaction is executed using credit or debit account information from the buyer, wherein the authorize-only credit or debit transaction conditionally binds the buyer to make a purchase associated with at least one of the content, event, product or service, only upon the satisfaction of the pre-defined criteria.

Upon the satisfaction of the pre-defined criteria, a credit or debit account of each buyer that made one of said conditional purchase requests is automatically charged, and the vendor is obligated to cause at least the content to be produced. Following satisfaction of the pre-defined criteria and during the production or development activities, the content is made available to each buyer that made one of the conditional purchase requests. The conditional purchase amounts specified in the conditional purchase requests include vendor-defined prices that are independent of an aggregate volume of conditional purchases made by the buyers.

In some embodiments, the pre-defined criteria represent criteria that must be satisfied before the vendor is obligated to cause the content and at least one of the event, product or service, to be produced. In these embodiments, upon the satisfaction of the pre-defined criteria, the vendor is obligated to cause the content and at least one of the event, product or service, to be produced. Further embodiments include defining, by the vendor, a period for a buyer to conditionally purchase at least one of the content, event, product or service over the network site.

The pre-defined criteria may represent criteria that must be satisfied before the vendor is obligated to cause the content and an event to be produced, and after the credit or debit account of a buyer is charged, the buyer is issued a ticket for the event.

In some embodiments, after the credit or debit account of a buyer is charged, the buyer is issued a receipt confirming the purchase of at least one of the content, event, product or service.

The vendor may offer to conditionally sell a plurality of content items, wherein each content item having its own pre-defined criteria. In these embodiments, the vendor becomes bound to produce only those content items that achieve the pre-defined criteria.

A secure area of the network site may be provided which includes a private account page accessible by a vendor that has created an account with the network site. Within the secure area, the vendor may view information updated to reflect the completion of a transaction. The vendor may also view the status of the progress toward satisfaction of the pre-defined criteria with respect to at least one of the content, event, product or service, on the vendor's private account page. In addition, the vendor may create a listing of information for new content, or a new event, product or service on a new page accessible by the vendor from the vendor's private account page.

In some embodiments, information concerning a future content item may be accessed using a public area of the network site, and a secure area of the network site is accessed for entering credit or debit account information in order to make a conditional purchase request. The credit or debit account information may be transmitted to a credit or debit account company over the network.

In some embodiments, the secure area of the website can optionally be used to permit the buyer to create an account page, and the completion of a purchase transaction is confirmed on the buyer's account page. Also, in such embodiments, the buyer may view the status of the progress toward satisfaction of the pre-defined criteria for a content item of interest on the buyer's account page, but only to the extent permitted by the vendor. The buyer may receive the content online through an area of the network site associated with the content on the network site or through a cable, satellite, or other digital network.

In some embodiments, the production or development activities concern production or development of an artistic work, and the content corresponds to efforts of a creator of the artistic work to produce the artistic work. Alternatively, the production or development activities concern production or development of a non-fiction work, and the content corresponds to efforts of a creator of the non-fiction work to produce the non-fiction work. In other embodiments, the production or development activities concern production or development of an interactive video game, and the content corresponds to efforts of a creator of the video game to produce the video game. In still further embodiments, the production or development activities concern production or development of a comic book, and the content corresponds to efforts of a creator of the comic book to produce the comic book.

In accordance with a further aspect, the present invention is directed to a system and method for making a sale of content online wherein the content conveys information related to production or development activities for an event, product or service. A network site accessible over a communication network from remote computers is provided. Pre-defined criteria are received from a vendor of the content. The pre-defined criteria must be satisfied before the vendor is obligated to cause the content to be produced. The pre-defined criteria is an aggregate threshold volume of conditional purchases that must be made by a plurality of different buyers for at least one of the content, event, product or service. In this embodiment, the vendor has an option to agree to cause the content to be produced even though the pre-defined criteria have not been satisfied.

Commercial terms relating to making a conditional purchase for at least the content, event, product or service, are displayed to the buyers over the network site. The commercial terms include one or more vendor-defined prices associated with the conditional purchase. The content is identified to the buyers over the network site. An agreement is received from the vendor to make the content available to each buyer in exchange for the conditional purchase during a time period following satisfaction of the pre-defined criteria and during the production or development activities.

Conditional purchase requests for at least one of the content, event, product or service, are received from the plurality of buyers over the network site. Each of the conditional purchase requests includes credit or debit account information from a buyer and specifies a conditional purchase amount that includes at least one of the vendor-defined prices. In response to each conditional purchase request, an authorize-only credit or debit transaction is executed using credit or debit account information from the buyer, wherein the authorize-only credit or debit transaction conditionally binds the buyer to make a purchase associated with at least one of the content, event, product or service only upon the satisfaction of the pre-defined criteria or upon the vender exercising the option.

Upon the vendor exercising the option to cause the content to be produced even though the pre-defined criteria have not been satisfied, a credit or debit account of each buyer that made one of said conditional purchase requests is automatically charged, and the vendor is obligated to cause at least the content to be produced. Following satisfaction of the pre-defined criteria or exercise of the option, and during the production or development activities, the content is made available to each buyer that made one of the conditional purchase requests. The conditional purchase amounts specified in the conditional purchase requests include vendor-defined prices that are independent of an aggregate volume of conditional purchases made by the buyers.

In accordance with a still further aspect, the present invention is directed to a method for making a conditional sale of a plurality of linked content items online, wherein each of the linked content items conveys information related to production or development activities for a different event, product or service. A network site accessible over a communication network from remote computers; is provided. Pre-defined criteria are received from a vendor of the plurality of linked content items. The pre-defined criteria must be satisfied before the vendor is obligated to cause a subset of the plurality of linked content items to be produced. The pre-defined criteria specify buyer demand parameters that determine which, if any, of the subset of the plurality of linked content items that the vendor is obligated to cause to be produced. The subset includes less than all of the plurality of linked content items.

Commercial terms relating to making a conditional purchase for one of the linked content items are displayed to the buyers over the network site. Each of the linked content items is identified to the buyers over the network site, and an agreement is received from the vendor to make the subset of linked content items available to each buyer of a linked content item in the subset in exchange for the conditional purchase of a linked content item in the subset during a time period following satisfaction of the pre-defined criteria and during the production or development activities (which commence after satisfaction of the pre-defined criteria.) Conditional purchase requests for each of the linked content items are received from the plurality of buyers over the network site. Each of said conditional purchase requests is associated with one of the linked content items, includes credit or debit account information from a buyer and specifies a conditional purchase amount. In response to each conditional purchase request, an authorize-only credit or debit transaction is executed using credit or debit account information from the buyer. The authorize-only credit or debit transaction conditionally binds the buyer to make a purchase for the linked content item associated with the conditional purchase of the buyer only upon the satisfaction of the pre-defined criteria for the linked content item associated with the conditional purchase of the buyer.

Upon the satisfaction of the pre-defined criteria associated with each linked content item in the subset, a credit or debit account of each buyer that made one of the conditional purchase requests associated with each linked content item in the subset is automatically charged, and the vendor is obligated to cause each linked content item in the subset to be produced. Following satisfaction of the pre-defined criteria associated with each linked content item in the subset, and during the production or development activities associated with each item of linked content for which the pre-defined criteria were satisfied, the linked content items in the subset are made available to each buyer that made one of the conditional purchase requests associated with each linked content item for which the pre-defined criteria were satisfied.

In accordance with a still further aspect, the present invention is directed to a method and system for conducting a fundraising event online in order to raise funds for supplying a charitable good or service to one or more beneficiaries. A network site accessible over a communication network from remote computers is provided. Pre-defined criteria are received from a sponsor of the event. The pre-defined criteria correspond to an aggregate threshold level of interest in the event. Terms relating to the event are displayed to a plurality of participants over the network site. Also displayed is a description of content relating to production, development or delivery of the charitable good or service to the one or more beneficiaries that the sponsor will make available to each participant in exchange for a conditional payment commitment during a time period following satisfaction of the pre-defined criteria and during production, development or delivery of the charitable good or service to the one or more beneficiaries.

Conditional payment commitments for the fundraising event are received from the plurality of participants over the network site. Each of the conditional payment commitments includes credit or debit account information from a participant and specifies a conditional payment commitment amount. In response to each conditional payment commitment, an authorize-only credit or debit transaction is executed using credit or debit account information from the participant. The authorize-only credit or debit transaction conditionally binds the participant to make a payment associated with the event only upon the satisfaction of the pre-defined criteria, wherein the predefined criteria corresponds to an aggregate threshold amount of conditional payment commitments that must be made for the event by the plurality of different participants. Upon the satisfaction of the pre-defined criteria, the credit or debit accounts of the participants that made the conditional payment commitments are automatically charged the conditional payment commitment amounts specified in the conditional payment commitments. Following satisfaction of the pre-defined criteria and during production, development or delivery of the charitable good or service to the one or more beneficiaries, the content relating to the development or delivery of the charitable good or service is made available to each participant that made a conditional payment commitment. The conditional payment commitments amounts specified in the conditional payment commitments include amounts that are independent of an aggregate amount of conditional payment commitments made for the fundraising event. In some of the fundraising embodiments, no goods or services are provided to the participants upon satisfaction of the pre-defined criteria.

In accordance with a still further aspect, the present invention is directed to a method for making a conditional sale of a novelty item associated with an event or an artistic work. A network site accessible over a communication network from remote computers is provided. Pre-defined criteria are received from a vendor of the event or artistic work. The pre-defined criteria correspond to criteria that must be satisfied before the vendor is obligated to cause the novelty item, event or artistic work to be produced. The pre-defined criteria include an aggregate threshold volume of conditional purchases that must be made by a plurality of different buyers for at least one of the novelty item, event or artistic work. Commercial terms relating to making a conditional purchase for at least one of the novelty item, event or artistic work, are displayed to the buyers over the network site. The commercial terms include one or more vendor-defined prices associated with the conditional purchase. The novelty item is identified to the buyers over the network site, and an agreement is received from the vendor to provide the novelty item to each buyer in exchange for the conditional purchase upon satisfaction of the pre-defined criteria.

Conditional purchase requests are received for at least one of the novelty item, event or artistic work, from the plurality of buyers over the network site. Each of the conditional purchase requests includes credit or debit account information from a buyer and specifies a conditional purchase amount that includes at least one of the vendor-defined prices. In response to each conditional purchase request, an authorize-only credit or debit transaction is executed using credit or debit account information from the buyer. The authorize-only credit or debit transaction conditionally binds the buyer to make a purchase associated with at least one of the novelty item, event or artistic work, only upon the satisfaction of the pre-defined criteria. Upon the satisfaction of the pre-defined criteria, a credit or debit account of each buyer that made one of the conditional purchase requests is automatically charged, and the vendor is obligated to cause at least the novelty item to be produced. Following satisfaction of the pre-defined criteria, the novelty item is provided to each buyer that made one of the conditional purchase requests. The conditional purchase amounts specified in the conditional purchase requests include vendor-defined prices that are independent of an aggregate volume of conditional purchases made by the buyers.

In some embodiments, the novelty item is a t-shirt, and the event corresponds to a concert featured on the t-shirt. Alternatively, the novelty item may be a t-shirt, and the artistic work corresponds to an album featured on the t-shirt. In a further embodiment, the novelty item is a hat, and the artistic work is a comic book.

In accordance with yet a further aspect, the present invention is directed to a method and system for conducting a fundraising event online in order to raise funds for producing a journalistic work. A network site accessible over a communication network from remote computers is provided. Pre-defined criteria are received from a sponsor of the journalistic work. The pre-defined criteria correspond to an aggregate threshold level of interest in the journalistic work. Terms relating to production or development of the journalistic work are displayed to a plurality of participants over the network site. Also displayed is a description of content relating to the journalistic work that the sponsor will make available to each participant in exchange for a conditional payment commitment during a time period following satisfaction of the pre-defined criteria. In some embodiments, the content comprises updates to a news story that are provided to the participants upon satisfaction of the pre-defined criteria.

Conditional payment commitments for the journalistic work are received from the plurality of participants over the network site. Each of the conditional payment commitments includes credit or debit account information from a participant and specifies a conditional payment commitment amount. In response to each conditional payment commitment, an authorize-only credit or debit transaction is executed using credit or debit account information from the participant. The authorize-only credit or debit transaction conditionally binds the participant to make a payment associated with the journalistic work only upon the satisfaction of the pre-defined criteria. The predefined criteria correspond to an aggregate threshold amount of conditional payment commitments that must be made for the journalistic work by the plurality of different participants. Upon the satisfaction of the pre-defined criteria, the credit or debit accounts of the participants that made said conditional payment commitments are automatically charged the conditional payment commitment amounts specified in the conditional payment commitments. Following satisfaction of the pre-defined criteria, the content relating to the journalistic work is made available to each participant that made a conditional payment commitment. The conditional payment commitments amounts specified in the conditional payment commitments include amounts that are independent of an aggregate amount of conditional payment commitments made for the journalistic work.

In accordance with a still further aspect, the present invention is directed to a method and system for conducting a fundraising event online in order to raise funds for at least one traveler to take a trip. A network site accessible over a communication network from remote computers is provided. Pre-defined criteria are received from at least one traveler. The pre-defined criteria correspond to an aggregate threshold level of interest in the trip. Terms relating to funding of the trip are displayed to a plurality of participants over the network site. Also displayed is a description of content relating to the trip that the at least one traveler will make available to each participant in exchange for a conditional payment commitment during a time period following satisfaction of the pre-defined criteria. In some embodiments, the content comprises travel updates about the trip that are provided to the participants upon satisfaction of the pre-defined criteria.

Conditional payment commitments for the trip are received from the plurality of participants over the network site. Each of the conditional payment commitments includes credit or debit account information from a participant and specifies a conditional payment commitment amount. In response to each conditional payment commitment, an authorize-only credit or debit transaction is executed using credit or debit account information from the participant. The authorize-only credit or debit transaction conditionally binds the participant to make a payment associated with the trip only upon the satisfaction of the pre-defined criteria, wherein the predefined criteria corresponds to an aggregate threshold amount of conditional payment commitments that must be made for the trip by the plurality of different participants. Upon the satisfaction of the pre-defined criteria, the credit or debit accounts of the participants that made the conditional payment commitments are automatically charged the conditional payment commitment amounts specified in the conditional payment commitments. Following satisfaction of the pre-defined criteria, the content relating to the trip is made available to each participant that made a conditional payment commitment. The conditional payment commitments amounts specified in the conditional payment commitments include amounts that are independent of an aggregate amount of conditional payment commitments made for the trip.

### BRIEF DESCRIPTION OF THE DRAWINGS

For a further understanding of the features and advantages of the present invention, reference should be made to the following Detailed Description taken in conjunction with the accompanying drawings wherein:

FIG. 1 is a block diagram of a website of the present invention.

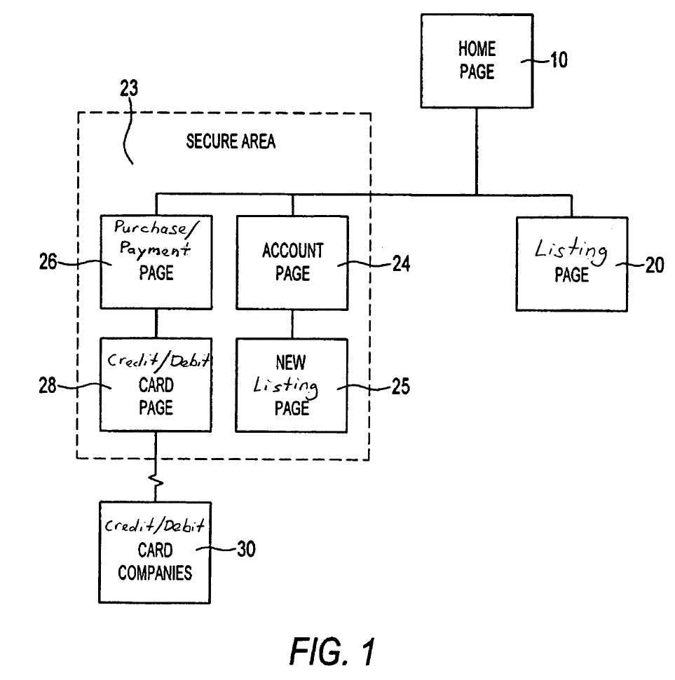

FIG. 2 is a block diagram showing the process of the present invention from the perspective of a buyer of an event.

FIG. 3 is a block diagram showing the process of the present invention from the perspective of a vendor of an event.

### DETAILED DESCRIPTION OF THE PREFERRED EMBODIMENT

The website of the present invention is hosted on a server having a database for storing information relating to any of the following types of listings: (i) posted events (e.g., a concert, sporting event, stage event, charter travel or other event), products or services, (ii) content relating to production or development activities for an event, product or service, (iii) the conducting of a fundraising event online in order to raise funds for supplying a charitable good or service to one or more beneficiaries, (iv) the conducting of a fundraising event online in order to raise funds for producing a journalistic work, (v) the conducting of a fundraising event online in order to raise funds for a traveler to take a trip, and (vi) the conditional sale of novelty items associated with an event or artistic work (collectively, “Listings”). The website includes functionality for collecting purchase information or payment commitments received from buyers or participants as further described below. The website can be accessed by buyers, participants, sponsors and vendors over the Internet from remote terminals and computer systems.

The website has a public, unsecured, area and a secure area 23. Generally, the public, unsecured area includes posted information relating to Listings. The public unsecured area permits prospective buyers or participants to view the information relating to such Listings. The secure area 23 permits buyers, participants, sponsors or vendors to create private accounts and permits buyers or participants to enter their credit or debit card information and to make transactions. As can be further appreciated from the description set forth below, the website can be hosted by either the actual sponsor or vendor associated with the Listings or through a third party intermediary that maintains a website for Listings on behalf of multiple sponsors or vendors.

The public area of the website consists of a home page 10. The home page is accessible by all prospective buyers, participants, sponsors and vendors visiting the website. The home page includes general information relating to the website and Listings. It also includes a log-in field for buyers, participants, sponsors and vendors to access their personal accounts. The home page also includes a search field that buyers may use to search Listings according to specified criteria such as by the type of event, product, service, content, the name of the Listing, the name of the artist, journalist, traveler or sponsor, the location or the sponsor or vendor. Such Listing may include a concert, sporting event, stage event, charter travel or other event. Such Listings could also include the introduction of a new product by a company such as “a film production company agreeing to produce a specific new film and provide ongoing ‘behind-the-scenes’ content to buyers while they wait for the delivery of the film if $500,000 can be raised by Jan. 1, 2007 through conditional sales of DVDs of the specific film for $25 per unit and downloads of the specific film for $10 per unit”. Other examples of Listings are described below.

From the home page 10, a prospective buyer or participant may link to the webpage for a specified Listing 20 if the buyer or participant has particular interest in such Listing. The Listing page 20 displays a detailed explanation of the Listing. In cases where the Listing corresponds to an event, this page displays: (i) the scheduled date and time of the event and information relating to the pricing and seating of the event, if applicable, and (ii) commercial terms and conditions relating to the conditional sale of the event, including, if applicable, a description of the content relating to the production and development activities for the event that will be produced and made available to buyers, and a statement of the pre-defined criteria set by the vendor for the event that must be achieved in order for the vendor to be obligated to produce or perform the event, and, if applicable, produce and deliver the content relating to the production and development activities of the event. Such pre-defined criteria include the pre-defined time period for the sales of the event to be conducted and may also include a specified level of total number of sales, a specified level of total sales income or other pre-defined conditions. In cases where the Listing corresponds to a new product, this page displays: (i) information relating to the pricing of the new product, and (ii) commercial terms and conditions relating to the conditional sale of the new product, including, if applicable, a description of the content relating to the production and development activities for the product that will be produced and made available to buyers, and a statement of the pre-defined criteria set by the vendor for the new product that must be achieved in order for the vendor to be obligated to produce the new product, and, if applicable, produce and deliver the content relating to the production and development activities of the new product. Such pre-defined criteria include the pre-defined time period for the sales of the event to be conducted and may also include a specified level of total number of sales, a specified level of total sales income or other pre-defined conditions. Other commercial terms displayed on the Listing page 20 may include other information regarding the artist or venue, if applicable. The event pricing structure information displayed on the Listing page 20 may include typical multi-tiered pricing for select seating if the Listing corresponds to an event, or select media (DVD, Download, on Demand, etc.) if the Listing corresponds to a film, and may display additional information relating to price discounts offered for certain purchases. The Listing page 20 may also permit a prospective buyer to view seating arrangements if the Listing corresponds to an event and any other information applicable to the Listing as desired by the vendor.

From the home page 10, the buyer, participant, sponsor or vendor may also access their account page 24. The account page 24 of each buyer, participant, sponsor or vendor is located on the secure area of the website 23 and may be accessed by the buyer, participant, sponsor or vendor only by entering their account identification and password. The account page 24 will be accessible by a buyer, participant, sponsor or vendor only after the buyer, participant, sponsor or vendor has created an account with the website.

Within the account page 24, the buyer, participant, sponsor or vendor may view the feature referred to herein as the “status of satisfaction feature” of the present invention. This feature permits a buyer, participant, sponsor or vendor to monitor the status of the pre-defined criteria relating to a Listing, to the extent permitted by the sponsor or vendor. For example, if the pre-defined criteria relates to a total number of sales, the status of satisfaction feature will display information in either textual or graphical form showing the number of sales as of such date and time. Alternatively, if the pre-defined criteria relates to a level of total sales income generated by the Listing, the status of satisfaction feature will display the level of total sales income authorized by credit or debit card companies for buyers or participants as of such date and time. The information viewed over the status of satisfaction feature of the present invention is referred to as the “status of satisfaction information” herein.

A buyer or participant is able to view such status of satisfaction information to the extent permitted by the vendor or sponsor. Depending on the terms and conditions of the conditional sale or payment commitment, the vendor or sponsor may restrict the information relating to a Listing displayed over the status of satisfaction feature by choosing various levels of transparency for the display of the status of satisfaction information to buyers or participants in relation to the Listing. For example, a vendor or sponsor may elect to have a completely blind conditional sale or payment commitment where buyers or participants are not permitted to monitor the satisfaction of the pre-defined criteria through the status of satisfaction feature. Alternatively, a vendor or sponsor may elect to have a partially or completely transparent sale or payment. In one embodiment of a partially transparent conditional sale or payment, the vendor or sponsor may allow buyers or participants to monitor status of satisfaction information that is only updated every 24 hours. In a fully transparent conditional sale or payment, buyers or participants would be able to monitor up-to-the-minute status of satisfaction information.

As an additional feature, a vendor or sponsor may elect to have certain status of satisfaction information displayed on the home page 10 or Listing page 20. For example, a vendor or sponsor may wish to display on the Listing page 20 the message “only 4 more tickets need to be sold” for a particular conditional event to become binding. A vendor or sponsor may elect to display different status of satisfaction information to buyers or participants through their account page 24 as compared to the status of satisfaction information made available over the home page 10 or Listing page 20 to the public.

In addition to status of satisfaction information, the account page 24 may also communicate other Listing or account related information to the buyer, participant, sponsor or the vendor, as discussed below.

From a vendor's or sponsor's account page 24, a vendor or sponsor may access a new listing page 25 where the vendor or sponsor may create a new Listing as desired by the vendor or sponsor. As further described herein, the information submitted by the vendor or sponsor over such new listing page 25 to create the new listing includes a description of the type of Listing, the pre-defined criteria including a pre-defined time period applicable to the Listing, other applicable terms and conditions, any pricing or payment structure for the Listing and any additional information relating to the Listing that the vendor or sponsor desires to be included. After such information has been submitted, the vendor or sponsor has the opportunity to review and correct such information. If such information is correct, the Listing will be included on a Listing 20 and accessible by prospective buyers and participants that access the website.

From the home page 10, a buyer or participant may access the Listing page 20 if the buyer or participant desires to get further information about a Listing. If the buyer or participant then wishes to make a purchase or payment with respect to the Listing, the buyer or participant will select the purchase/payment option link on the Listing page 20 and will enter the purchase/payment page 26. In a case where a Listing corresponds to a concert, sporting or theatrical event, or similar event, the purchase page 26 permits a prospective buyer to select the number of tickets or product to be purchased, the type of ticket or product to be purchased, and other choices, if applicable. In a case where a Listing corresponds to a specific film, a specific album, or other video or audio product, the purchase page 26 permits a prospective buyer to select the number of products to be purchased, the type of media delivery or product to be purchased, for example the specific film delivered on DVD or via download or by corresponding movie theater ticket or the specific album delivered on CD or via download, and other choices, if applicable.

Purchase/payment page 26 permits the buyer or participant to view the terms and conditions that shall apply to the conditional sale or payment commitment for the Listing. By making a conditional purchase or payment with respect to a Listing, the buyer or participant is agreeing to the displayed terms and conditions including having the purchase/payment amount authorized by its credit or debit card company utilizing an “authorize only” transaction. From the purchase/payment page 26, the buyer or participant may enter credit or debit card page 28 to initiate a transaction.

On the credit or debit card page 28, there is a prompt area that requires the buyer or participant to enter their credit or debit card and other information to be used to authorize the transaction.

The system of the present invention is interfaced with various credit or debit card companies 30. Once the buyer's or participant's credit or debit card information is entered, the system communicates with the credit or debit card company of the buyer/participant over a communication network to receive authorization for a future charge. The buyer's or participant's credit or debit card company must approve the authorization of future charges before the transaction will be approved by the system. This method of securing payment is in wide use in the credit or debit card industry. Although credit cards are the most common method of payment, one of ordinary skill in the art can appreciate that other mechanisms of payment may be used with the website including debit cards or other payment mechanisms that can guarantee future payment of pre-authorized transactions.

The credit or debit card company 30 processes the authorization request and transmits an “approved” or “declined” message to the website. The system then immediately notifies the buyer/participant of whether the credit or debit card company has either approved or declined the authorization.

If the charge is authorized, at this point, the buyer/participant and the sponsor/vendor become bound by the conditional terms and conditions. The buyer/participant is bound to pay the purchase price/payment amount with respect to the Listing and the vendor/sponsor is bound to produce, perform and/or make available an event, product, service and/or unique content upon the satisfaction of the pre-defined criteria.

Also, upon confirmation of the credit or debit card authorization, the host database is updated by the system to reflect the transaction. The account page 24 for the buyer/participant and the account page 24 for the vendor/sponsor are updated to reflect the transaction.

Through the additional linked-event, or linked-Listing, feature of the present invention, vendors/sponsors have the ability to list two or more conditional Listings simultaneously while having to only produce those Listings that achieve the desired threshold of demand as reflected in the pre-defined criteria. This linked-event feature allows vendors/sponsors to have buyer/participants demand dictate which of the linked Listings move forward. For example, a concert for the same band could be scheduled on the same night in two or more cities, with the one best satisfying the vendor's pre-defined criteria being the one staged; or a linked-Listing for the production of a new film could conditionally offer the same film with two or more different possible staring actors, with the Listing best satisfying the vendor's pre-defined criteria being the one produced. As another example, a vendor might set its pre-defined criteria as “most ticket sales income as of Jul. 1, 2005”, and the vendor would only be obligated to produce the concert that had generated the most ticket sales income as of Jul. 1, 2005.

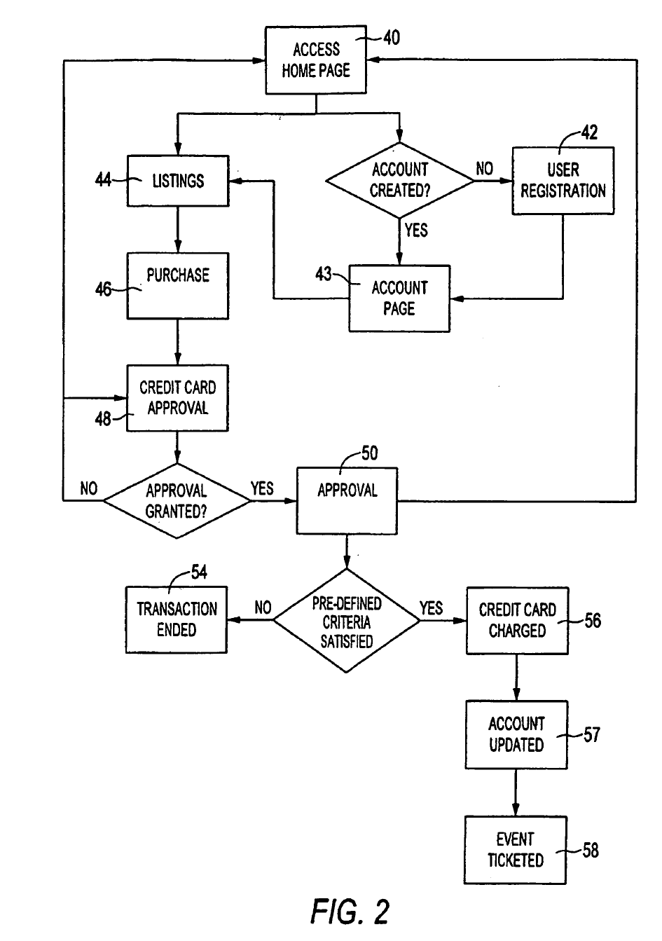

The process of the present invention from the perspective of the buyer/participant is shown in greater detail in FIG. 2. The first step is for the buyer/participant to access the home page 40 from a remote terminal and enter the public area of the website. The home page includes a search field that buyers/participants may use to search the Listings 44 according to criteria specified by the buyer/participant. The home page also includes a log-in field for buyers/participants to access their individual account page 43. If the buyer/participant has an account already set up with the website, the buyer/participant may log-in to their account page 43 by entering their account identification and password. If the buyer/participant does not have an account, the buyer/participant may register with the website by entering information and creating a new account 42. Once an account is established, the buyer/participant may then access its personal account page 43 where status of satisfaction information, account information and information relating to Listings purchased and monitored are displayed. The account page also includes a search field that buyers/participants may use to search the listings 44.

Alternatively, if the buyer/participant does not have an account or the buyer/participant elects not to access their account page, the buyer/participant may begin viewing information regarding the Listings directly by linking to the event listings 44 from the home page either through a search or a selection of a category.

If the buyer/participant is interested in a Listing, the buyer/participant will link to that Listing's page for further information relating to the Listing, including information explaining the vendor's/sponsor's pre-defined criteria including the pre-defined time period set for the Listing. If the buyer/participant then wishes to make a purchase with respect to the Listing, the buyer/participant will select the purchase/payment option on the page and will be prompted to log-in prior to entering the purchase/payment page. If the buyer/participant does not have an account, the buyer/participant may register with the website and create an account, before being forwarded to the purchase/payment page.

Once on the purchase/payment page, the buyer/participant will select the details relating to their purchase/payment order. In cases where a Listing corresponds to a concert or sporting event, such details may include the number of tickets, seating choices, and preferred delivery methods in order to purchase the event 46. In a case where a Listing corresponds to a specific film, a specific album, or other video or audio product, such details may include the number of products to be purchased, the type of media delivery or product to be purchased, for example the specific film delivered on DVD or via download or by corresponding movie theater ticket or the specific album delivered on CD or via download, and other choices, if applicable. In cases where the listing corresponds to a fundraising event, such details may include the amount of a conditional payment commitment that the participant is willing to make with respect to the fundraising event. The buyer/participant then may proceed to the credit or debit card submission page to obtain credit or debit card approval 48. The buyer/participant then submits its credit or debit card and corresponding information. Once the buyer's or participant's credit or debit card information has been entered, the credit or debit card is processed for authorization approval via a communication link with the buyer's or participant's credit or debit card company. The credit or debit card company will either approve or decline the credit or debit card authorization. If the credit or debit card authorization is declined, the buyer/participant is returned to the credit or debit card submission page. The buyer/participant may then review the information just submitted to determine if there was an error or may try another credit or debit card. Otherwise, the buyer/participant may return to the home page 40 or exit the website.

If the credit or debit card authorization is approved, the buyer/participant is notified that the authorization was successful 50. The buyer/participant may then return to the home page 40 and begin the process all over for another Listing if desired or the buyer/participant may return to their account page 43 or exit the website.

After each authorized transaction, the system will update the database with respect to the applicable Listing. For example, if the pre-defined criteria relates to a total number of sales then the number of sales just completed shall increase the current count for the total sales number. If the pre-defined criteria relates to a total sales income amount, the total sales income amount will be increased by the revenue from the sales completed. After each authorized transaction the status of satisfaction information available to buyers, participants, sponsors and vendors will be updated as specified in the terms and conditions of that Listing.

At the expiration of the pre-defined time period, the system will check to determine whether the pre-defined criteria have been satisfied. If the pre-defined criteria are not fulfilled upon the expiration of the pre-defined time period, then the buyer's or participant's credit or debit card is not charged and the transaction is ended 54. Also, the vendor or sponsor is not obligated to produce anything with respect to the Listing.

If the pre-defined criteria are fulfilled at any time prior to the expiration of the pre-defined time period, then, at such time, the buyer's/participant's credit or debit card account is charged 56. The buyer's/participant's account page is then updated to reflect the completion of the transaction 57. In the case of some Listings, the buyer/participant may be issued an e-ticket, ticket by mail, receipt or other purchase confirmation 58. The vendor/sponsor is then obligated to produce, perform and/or make available an event, product, service and/or unique content upon the satisfaction of the pre-defined criteria.

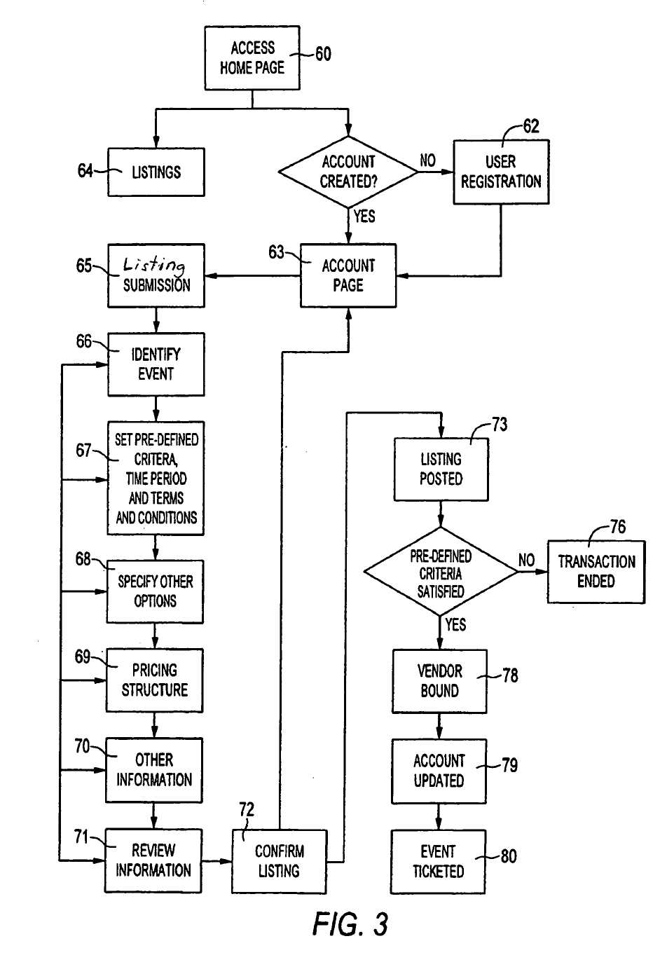

The process of the present invention from the perspective of the vendor/sponsor is shown in greater detail in FIG. 3. The vendor/sponsor may access the website from a remote terminal similar to the buyer/participant and enter the website at the home page 60. The home page includes a log-in field for vendors/sponsors to access their account page 63. If the vendor/sponsor has already established an account with the website, the vendor/sponsor may log-in to their account page 63. If the vendor/sponsor is a new user or has otherwise not yet established an individual account, the vendor/sponsor may register with the website by entering information and creating a new account 62. Once an account is established the vendor/sponsor may then access their private account page 63. On its account page, the vendor/sponsor may view status of satisfaction information relating to any Listings associated with the vendor/sponsor and other information relating to their account. From the home page, the vendor/sponsor may also access the Listings on the website and view Listings provided by other vendors/sponsors.

If the vendor/sponsor desires to provide a new Listing, the vendor/sponsor will enter the new Listing submission page 65 from their account page 63. In order for the vendor/sponsor to submit information for a new Listing, the vendor/sponsor must be a registered user of the website. In order to submit a new Listing, the vendor/sponsor must identify the type of Listing such as whether the Listing corresponds to a staged event, charter service, physical achievement, product development, fundraising event, sale of unique content, or the like 66. The vendor/sponsor then selects the pre-defined criteria applicable to the Listing, including a pre-defined time period during which transactions will be accepted, and further sets the terms and conditions applicable to the conditional sale/purchase commitment 67. The vendor/sponsor then selects other criteria options applicable to the Listing such as the linked feature, as applicable 68. The vendor/sponsor then selects any pricing structure for the Listing such as the various pricing tiers and possible discounts to early buyers or other such pricing related options 69. Finally, the vendor/sponsor provides information relating to the Listing such as the date, time, and location, and other relevant information, as applicable 70. After the vendor/sponsor enters all of the listing information, the vendor/sponsor has the opportunity to review the listing information and confirm its accuracy 71. If there are any corrections that should be made, the vendor/sponsor may return to any of the new Listing submission steps to make any revisions that are necessary. If all of the information submitted is accurate, the vendor/sponsor confirms the Listing 72. At this point, the Listing is submitted to the website and the vendor/sponsor may return to their account page 63 if desired. The Listing will be posted on the website together with any other Listings from such vendor/sponsor or any listings from any other vendors/sponsors at the date and time selected by the vendor/sponsor.

Once the Listing is posted, the system will begin accepting conditional sale/payment transactions from buyers 73.

At the expiration of the pre-defined time period, the system will check to determine whether the pre-defined criteria have been satisfied. If the pre-defined criteria are not fulfilled by the pre-defined time period, the vendor/sponsor is not obligated to produce or perform anything with respect to the Listing and the transaction is ended 76. If the pre-defined criteria are satisfied at any time prior to the expiration of the pre-defined time period, then, at such time, all of the pre-authorized buyers/participants with respect to the Listing are charged, and at that moment the vendor/sponsor becomes obligated to perform 78. The account pages of the buyers/participants and the vendor/sponsor are then updated to reflect the satisfaction of the pre-defined criteria 79. Finally, in some embodiments, the buyer is issued an e-ticket, ticket by mail, receipt or other purchase confirmation 80, as applicable, and the vendor/sponsor produces, performs and/or makes available an event, product, service and/or unique content associated with the Listing.

In an alternative embodiment of the present invention, the vendor/sponsor has an option to make the Listing binding and accept all conditional purchases/payments made by buyers/participants even if the pre-defined criteria are not satisfied. For this option to be available to the vendor/sponsor, a detailed explanation of such option must be included in the Listing terms and conditions that are reviewed and agreed to by the buyer/participant for that particular Listing. In exercising such option, the vendor/sponsor may accept the current level of conditional sales/payment commitments and bind itself to produce the Listing and charge the buyers/participants at that point. For a vendor/sponsor, this is more efficient than re-submitting a Listing with criteria that are at lower levels.

For purposes of illustration, several examples of the present invention are set forth below:

### EXAMPLE 1

### Conditional Sale Of Content

In one embodiment, the website is used to make a conditional sale of content online, wherein the content conveys information related to production or development activities for an event, product or service. In this embodiment, the pre-defined criteria are received from a vendor of the content and must be satisfied before the vendor is obligated to cause the content to be produced. The pre-defined criteria include an aggregate threshold volume of conditional purchases that must be made by a plurality of different buyers for at least one of the content, event, product or service.

In this embodiment, commercial terms relating to making a conditional purchase for at least one of the content, event, product or service, are displayed to the buyers over the website. The content is also identified to the buyers over the website. The vendor agrees to make the content available to each buyer in exchange for the conditional purchase during a time period following satisfaction of the pre-defined criteria and during the production or development activities (which commence after satisfaction of the pre-defined criteria.)

In some embodiments, the pre-defined criteria represent criteria that must be satisfied before the vendor is obligated to cause the content and at least one of the event, product or service, to be produced. The pre-defined criteria may represent criteria that must be satisfied before the vendor is obligated to cause the content and an event to be produced, and after the credit or debit account of a buyer is charged, the buyer is issued a ticket for the event.

The production or development activities may concern production or development of an artistic work, and in such cases, the content may corresponds to efforts of a creator of the artistic work to produce the artistic work. Alternatively, the production or development activities may concern production or development of a non-fiction work, and in such cases, the content may correspond to efforts of a creator of the non-fiction work to produce the non-fiction work. In other embodiments, the production or development activities may concern production or development of an interactive video game, and in such cases, the content may correspond to efforts of a creator of the video game to produce the video game. In still further embodiments, the production or development activities may concern production or development of a comic book, and in such cases, the content may correspond to efforts of a creator of the comic book to produce the comic book.

For example, a vendor may wish to raise $500,000 to produce a specific new film: The vendor conditionally offers to produce the film and provide ongoing “behind-the-scenes” content relating to the production or development activities of the film to buyers while they wait for the delivery of the film if the $500,000 can be raised by Jan. 1, 2007 through conditional sales of DVDs of the specific film for $25 per unit and downloads of the specific film for $10 per unit.

In another example, a vendor may wish to raise $50,000 to produce a specific new music album: The vendor conditionally offers to produce the album and provide ongoing “behind-the-scenes” content relating to the production or development activities of the album to buyers while they wait for the delivery of the album if the $50,000 can be raised by Jan. 1, 2007 through conditional sales of CDs of the specific album for $15 per unit and downloads of the specific album for $8 per unit.

In yet another example, a vendor may wish to raise $350,000 to produce a specific new video game: The vendor conditionally offers to produce the video game and provide ongoing “behind-the-scenes” content relating to the production or development activities of the video game to buyers while they wait for the delivery of the video game if the $350,000 can be raised by Jan. 1, 2007 through conditional sales of DVDs of the specific video game for $45 per unit and downloads of the specific video game for $35 per unit.

In yet another example, a vendor may wish to raise $100,000 to produce a specific new comic book: The vendor conditionally offers to produce the comic book and provide ongoing “behind-the-scenes” content relating to the production or development activities of the comic book to buyers while they wait for the delivery of the comic book if the $100,000 can be raised by Jan. 1,2007 through conditional sales of hard copies of the specific comic book for $10 per unit and downloads of the specific comic book for $3 per unit.

In yet another example, a vendor may wish to raise $200,000 to produce a specific new book: The vendor conditionally offers to produce the book and provide ongoing “behind-the-scenes” content relating to the production or development activities of the book to buyers while they wait for the delivery of the book if the $200,000 can be raised by Jan. 1, 2007 through conditional sales of hard copies of the specific book for $20 per unit and downloads of the specific book for $10 per unit.

In yet another example, a vendor may wish to raise $300,000 to produce a specific new documentary film: The vendor conditionally offers to produce the documentary film and provide ongoing “behind-the-scenes” content relating to the production or development activities of the documentary film to buyers while they wait for the delivery of the documentary film if the $300,000 can be raised by Jan. 1, 2007 through conditional sales of DVDs of the specific documentary film for $20 per unit and downloads of the specific documentary film for $10 per unit.

In yet another example, a vendor may wish to raise $80,000 to produce a specific new concert event: The vendor conditionally offers to produce the concert event and provide ongoing content relating to the production or development activities of the concert event to buyers while they wait for the delivery of the concert event if the $80,000 can be raised by Jan. 1, 2007 through conditional sales of tickets to the specific concert event for $20 per box-seat ticket and $10 per balcony-seat ticket.

In yet another example, a vendor may wish to raise $10,000 to produce a specific new music video: The vendor conditionally offers to produce the music video and provide ongoing content relating to the production or development activities of the music video to buyers if the $10,000 can be raised by Jan. 1, 2007 through conditional sales of the content relating to the production or development activities of the music video for $3 per unit.

In yet another example, a vendor may wish to raise $150,000 to produce a specific new version of a film, such as a digitally re-mastered version: The vendor conditionally offers to produce the new version of the film and provide ongoing content relating to the production or development activities of the new version of the film to buyers while they wait for the delivery of the new version of the film if the $150,000 can be raised by Jan. 1, 2007 through conditional sales of DVDs of the specific new version of the film for $20 per unit and downloads of the specific new version of the film for $10 per unit.

In yet another example, a vendor may wish to raise $10,000,000 to produce a specific new 10-episode science-fiction series: The vendor conditionally offers to produce the series and provide ongoing “behind-the-scenes” content relating to the production or development activities of the series to buyers while they wait for the delivery of the each episode of the series if the $10,000,000 can be raised by Jan. 1, 2007 through conditional sales of DVDs of the specific series for $50 per unit, downloads of the specific series for $35 per unit, and on Demand digital cable access to the specific series for $40 per unit.

### EXAMPLE 2

### Fundraising for Charitable Good or Service

In another embodiment, the website is used for conducting a fundraising event online in order to raise funds for supplying a charitable good or service to one or more beneficiaries. Pre-defined criteria are received from a sponsor of the event. The pre-defined criteria correspond to an aggregate threshold level of interest in the event. Terms relating to the event are displayed to a plurality of participants over the website. Also displayed is a description of content relating to production, development or delivery of the charitable good or service to the one or more beneficiaries that the sponsor will make available to each participant in exchange for a conditional payment commitment during a time period following satisfaction of the pre-defined criteria and during production, development or delivery of the charitable good or service to the one or more beneficiaries. In some of the fundraising embodiments, no goods or services (other than providing of the content) are provided to the participants upon satisfaction of the pre-defined criteria.

For example, a sponsor may wish to raise $10,000 to renovate his sick neighbor's kitchen: The vendor conditionally offers to renovate the kitchen and provide ongoing content relating to the production, development or delivery of the kitchen renovation to buyers if the $10,000 can be raised by Jan. 1, 2007 through conditional payments.

In another example, a sponsor may wish to raise $400,000 to landscape a large park: The vendor conditionally offers to landscape the park and provide ongoing content relating to the production, development or delivery of the landscaping of the park to buyers if the $400,000 can be raised by Jan. 1, 2007 through conditional sales of weekend park passes for $25 per unit.

### EXAMPLE 3

### Conditional Sale Of Novelty Item

In a further example, the website is used for making a conditional sale of a novelty item associated with an event or an artistic work. Pre-defined criteria are received from a vendor of the event or artistic work. The pre-defined criteria correspond to criteria that must be satisfied before the vendor is obligated to cause the novelty item, event or artistic work to be produced. The pre-defined criteria include an aggregate threshold volume of conditional purchases that must be made by a plurality of different buyers for at least one of the novelty item, event or artistic work. Commercial terms relating to making a conditional purchase for at least one of the novelty item, event or artistic work, are displayed to the buyers over the website. The novelty item is identified to the buyers over the website, and an agreement is received from the vendor to provide the novelty item to each buyer in exchange for the conditional purchase upon satisfaction of the pre-defined criteria. In some embodiments, the novelty item is a t-shirt, and the event corresponds to a concert featured on the t-shirt. Alternatively, the novelty item may be a t-shirt, and the artistic work corresponds to an album featured on the t-shirt. In a further embodiment, the novelty item is a hat, and the artistic work is a comic book.

For example, a vendor may wish to raise $50,000 to produce a specific new music album: The vendor conditionally offers to produce the album and a t-shirt corresponding to the specific album if the $50,000 can be raised by Jan. 1, 2007 through conditional sales of the t-shirt for $15 per unit.

In another example, a vendor may wish to raise $20,000 to produce a specific new comic book: The vendor conditionally offers to produce the comic book and a hat corresponding to the specific comic book if the $20,000 can be raised by Jan. 1, 2007 through conditional sales of the hat for $12 per unit.

In yet another example, a vendor may wish to raise $50,000 to produce a specific concert event: The vendor conditionally offers to produce the concert event and a poster corresponding to the specific concert event if the $50,000 can be raised by Jan. 1, 2007 through conditional sales of the poster for $12 per unit.

### EXAMPLE 4

### Fundraising Event for Journalistic Work

In another example, the website is used for conducting a fundraising event online in order to raise funds for producing a journalistic work. Pre-defined criteria are received from a sponsor of the journalistic work. The pre-defined criteria correspond to an aggregate threshold level of interest in the journalistic work. Terms relating to production or development of the journalistic work are displayed to a plurality of participants over the website. Also displayed is a description of content relating to the journalistic work that the sponsor will make available to each participant in exchange for a conditional payment commitment during a time period following satisfaction of the pre-defined criteria. In some embodiments, the content comprises updates to a news story that are provided to the participants upon satisfaction of the pre-defined criteria.

For example, a sponsor may wish to raise $10,000 to produce a specific new journalistic work on refugees in Sudan: The sponsor conditionally offers to produce the journalistic work on refugees in Sudan and provide ongoing content relating to the production or development activities of the journalistic work to buyers if the $10,000 can be raised by Jan. 1, 2007 through conditional sales of DVDs of the specific journalistic work for $15 per unit and downloads of the specific journalistic work for $10 per unit.

In yet another example, a sponsor may wish to raise $10,000 to produce a specific new journalistic work on international airline safety: The sponsor conditionally offers to produce the journalistic work on international airline safety which comprises providing ongoing content updates of the specific journalistic work to buyers if the $10,000 can be raised by Jan. 1, 2007 through conditional sales of the content relating to the specific journalistic work for $5 per unit.

### EXAMPLE 5

### Fundraising Event For Travel Expenses

In another example, the website is used for conducting a fundraising event online in order to raise funds for at least one traveler to take a trip. Pre-defined criteria are received from at least one traveler. The pre-defined criteria correspond to an aggregate threshold level of interest in the trip. Terms relating to funding of the trip are displayed to a plurality of participants over the network site. Also displayed is a description of content relating to the trip that the at least one traveler will make available to each participant in exchange for a conditional payment commitment during a time period following satisfaction of the pre-defined criteria. In some embodiments, the content comprises travel updates about the trip that are provided to the participants upon satisfaction of the pre-defined criteria.

For example, a sponsor may wish to raise $3,000 to finance a little league baseball team's travel expenses for a specific trip or series of trips: The sponsor conditionally offers to used the funds raised to finance the little league team's travel expenses and provide ongoing content relating to the specific trip to buyers if the $3,000 can be raised by Jan. 1, 2007 through conditional payments.

In another example, a traveler may wish to raise $10,000 to finance a cross-country drive: The traveler conditionally offers to use the funds raised to finance their cross-country drive and provide ongoing content relating to the trip to buyers if the $10,000 can be raised by Jan. 1, 2007 through conditional sales the content relating to the specific trip for $5 per unit.

In yet another example, a music group may wish to raise $5,000 to finance a multi-concert tour: The music group conditionally offers to use the funds raised to finance their tour and provide ongoing content relating to the trip to buyers if the $5,000 can be raised by Jan. 1, 2007 through conditional sales the content relating to the specific trip for $2 per unit.

Although a preferred embodiment of the present invention has been described in the foregoing Detailed Description and has been illustrated in the accompanying Figures, it will be understood that the invention is not limited to the embodiment disclosed but is capable of numerous modifications without departing from the scope of the invention claimed. Also, although the methods disclosed herein have been described and shown with reference to particular steps performed in a particular order, it will be understood that these steps may be combined, sub-divided or re-ordered to form an equivalent method without departing from the teachings of the present invention. Accordingly, unless specifically indicated herein, the order and grouping of the steps is not a limitation of the present invention.

What is claimed is:

1. A method for making a conditional sale of content online, wherein the content conveys information related to production or development activities for an event, product or service, the method comprising:
providing a network site accessible over a communication network from remote computers;
receiving, from a vendor of the content, pre-defined criteria that must be satisfied before the vendor is obligated to cause the content to be produced, wherein the pre-defined criteria includes an aggregate threshold volume of conditional purchases that must be made by a plurality of different buyers for at least one of the content, event, product or service;
displaying commercial terms relating to making a conditional purchase for at least one of the content, event, product or service, to the buyers over the network site, wherein the commercial terms include one or more vendor-defined prices associated with the conditional purchase;
identifying the content to the buyers over the network site, and receiving an agreement from the vendor to make the content available to each buyer in exchange for the conditional purchase during a time period following satisfaction of the pre-defined criteria and during said production or development activities, wherein said production or development activities commence after satisfaction of the pre-defined criteria;
receiving conditional purchase requests for at least one of the content, event, product or service, from the plurality of buyers over the network site, each of said conditional purchase requests including credit or debit account information from a buyer and specifying a conditional purchase amount that includes at least one of the vendor-defined prices, and in response to each conditional purchase request, executing an authorize-only credit or debit transaction using credit or debit account information from the buyer, wherein the authorize-only credit or debit transaction conditionally binds the buyer to make a purchase associated with at least one of the content, event, product or service, only upon the satisfaction of the pre-defined criteria; and
upon the satisfaction of the pre-defined criteria, automatically charging a credit or debit account of each buyer that made one of said conditional purchase requests, and obligating the vendor to cause at least the content to be produced;
following satisfaction of the pre-defined criteria and during the production or development activities, making the content available to each buyer that made one of said conditional purchase requests; and
wherein the conditional purchase amounts specified in the conditional purchase requests include vendor-defined prices that are independent of an aggregate volume of conditional purchases made by the buyers.

2. The method of claim 1:
wherein the pre-defined criteria comprise criteria that must be satisfied before the vendor is obligated to cause the content and at least one of the event, product or service, to be produced; and
wherein, upon the satisfaction of the pre-defined criteria, the vendor is obligated to cause the content and at least one of the event, product or service, to be produced.

3. The method of claim 1, further comprising defining, by the vendor, a period for a buyer to conditionally purchase at least one of the content, event, product or service over the network site.

4. The method of claim 1 wherein the pre-defined criteria comprise criteria that must be satisfied before the vendor is obligated to cause the content and an event to be produced, and after the credit or debit account of a buyer is charged, the buyer is issued a ticket for the event.

5. The method of claim 1 wherein, after the credit or debit account of a buyer is charged, the buyer is issued a receipt confirming the purchase of at least one of the content, event, product or service.

6. The method of claim 1 wherein the vendor offers to conditionally sell a plurality of content items, each content item having its own pre-defined criteria, the vendor becoming bound to produce only those content items that achieve the pre-defined criteria.

7. The method of claim 1 further comprising providing for a secure area of the network site, the secure area including a private account page accessible by a vendor that has created an account with the network site.

8. The method of claim 7 wherein the vendor may view, within the secure area, information updated to reflect the completion of a transaction.

9. The method of claim 7 wherein the vendor may view the status of the progress toward satisfaction of the pre-defined criteria with respect to at least one of the content, event, product or service, on the vendor's private account page.

10. The method of claim 7 wherein the vendor may create a listing of information for new content, or a new event, product or service on a new page accessible by the vendor from the vendor's private account page, the information displayed on the network site and sales of the new content, or new event, product or service completed.

11. The method of claim 1, wherein information concerning a future content item is accessed using a public area of the network site; a secure area of the network site is accessed for entering credit or debit account information in order to make a conditional purchase request, the method further comprising transmitting the credit or debit account information to a credit or debit account company over the network.

12. The method of claim 11 further comprising accessing the secure area of the website, the secure area permitting the buyer to create an account page.

13. The method of claim 12 wherein the completion of a purchase transaction is confirmed on the buyer's account page.

14. The method of claim 12 wherein the buyer may view the status of the progress toward satisfaction of the pre-defined criteria for a content item of interest on the buyer's account page, but only to the extent permitted by the vendor.

15. The method of claim 1, wherein the buyer receives the content online through an area of the network site associated with the content on the network site or through a cable, satellite, or other digital network.

16. The method of claim 1, wherein the production or development activities concern production or development of a product comprising an artistic work, and the content corresponds to efforts of a creator of the artistic work to produce the artistic work.

17. The method of claim 1, wherein the production or development activities concern production or development of a product comprising a non-fiction work, and the content corresponds to efforts of a creator of the non-fiction work to produce the non-fiction work.

18. The method of claim 1, wherein the production or development activities concern production or development of a product comprising an interactive video game, and the content corresponds to efforts of a creator of the video game to produce the video game.

19. The method of claim 1, wherein the production or development activities concern production or development of a product comprising a comic book, and the content corresponds to efforts of a creator of the comic book to produce the comic book.

20. A system for making a conditional sale of content online, wherein the content conveys information related to production or development activities for an event, product or service, the system comprising:
a network site accessible over a communication network from remote computers;
means for receiving, from a vendor of the content, pre-defined criteria that must be satisfied before the vendor is obligated to cause the content to be produced; wherein the pre-defined criteria is an aggregate threshold volume of conditional purchases that must be made by a plurality of different buyers for at least one of the content, event, product or service;
means for displaying commercial terms relating to making a conditional purchase for at least one of the content, event, product or service, to the buyers over the network site, wherein the commercial terms include one or more vendor-defined prices associated with the conditional purchase;
means for identifying the content to the buyers over the network site, and receiving an agreement from the vendor to make the content available to each buyer in exchange for the conditional purchase during a time period following satisfaction of the pre-defined criteria and during said production or development activities, wherein said production or development activities commence after satisfaction of the pre-defined criteria;
means for receiving conditional purchase requests for at least of the content, event, product or service, from the plurality of buyers over the network site, each of said conditional purchase requests including credit or debit account information from a buyer and specifying a conditional purchase amount that includes at least one of the vendor-defined prices;
means, responsive to each conditional purchase request, for executing an authorize-only credit or debit transaction using credit or debit account information from the buyer, wherein the authorize-only credit or debit transaction conditionally binds the buyer to make a purchase associated with at least one of the content, event, product or service, only upon the satisfaction of the pre-defined criteria; and
means, responsive to the satisfaction of the pre-defined criteria, for automatically charging a credit or debit account of each buyer that made one of said conditional purchase requests and obligating the vendor to cause the content to be produced;
means for making the content available to each buyer that made one of said conditional purchase requests following satisfaction of the pre-defined criteria and during the production or development activities; and
wherein the conditional purchase amounts specified in the conditional purchase requests include vendor-defined prices that are independent of an aggregate volume of conditional purchases made by the buyers.

21. The system of claim 20, further comprising, means for defining, by the vendor, a period for a buyer to make a purchase of at least one of the content, event, product or service over the network site.

22. The system of claim 20, wherein the predefined criteria comprise criteria that must be satisfied before the vendor is obligated to cause the content and an event to be produced, and, further comprising means for issuing a ticket for the event to a buyer after the credit or debit account of the buyer is charged.

23. The system of claim 20 further comprising means for issuing a receipt confirmation for at least one of the content, event, product or service, to a buyer after the credit or debit account of the buyer is charged.

24. The system of claim 20 further comprising means for monitoring the satisfaction of the pre-defined criteria and displaying information relating to the pre-defined criteria over a private account page.

25. The system of claim 20, wherein the production or development activities concern production or development of a product comprising an artistic work, and the content corresponds to efforts of a creator of the artistic work to produce the artistic work.

26. The system of claim 20, wherein the production or development activities concern production or development of a product comprising a non-fiction work, and the content corresponds to efforts of a creator of the non-fiction work to produce the non-fiction work.

27. The system of claim 20, wherein the production or development activities concern production or development of a product comprising an interactive video game, and the content corresponds to efforts of a creator of the video game to produce the video game.

28. The system of claim 20, wherein the production or development activities concern production or development of a product comprising a comic book, and the content corresponds to efforts of a creator of the comic book to produce the comic book.

29. The system of claim 20:
wherein the pre-defined criteria comprise criteria that must be satisfied before the vendor is obligated to cause the content and at least one of the event, product or service, to be produced; and
wherein, upon the satisfaction of the pre-defined criteria, the vendor is obligated to cause the content and at least one of the event, product or service, to be produced.

30. A computer useable medium and computer readable code embodied on the computer useable medium for making a conditional sale of content online wherein the content conveys information related to production or development activities for an event, product or service, the computer readable code comprising code which, when executed by a processor, performs the following steps:
providing a network site accessible over a communication network from remote computers;
receiving, from a vendor of the content, pre-defined criteria that must be satisfied before the vendor is obligated to cause the content to be produced, wherein the pre-defined criteria is an aggregate threshold volume of conditional purchases that must be made by a plurality of different buyers for at least one of the content, event, product or service;
displaying commercial terms relating to making a conditional purchase for at least one of the content, event, product or service, to the buyers over the network site, wherein the commercial terms include one or more vendor-defined prices associated with the conditional purchase;
identifying the content to the buyers over the network site, and receiving an agreement from the vendor to make the content available to each buyer in exchange for the conditional purchase during a time period following satisfaction of the pre-defined criteria and during said production or development activities, wherein said production or development activities commence after satisfaction of the pre-defined criteria; receiving conditional purchase requests for at least one of the content, event, product or service from the plurality of buyers over the network site, each of said conditional purchase requests including credit or debit account information from a buyer and specifying a conditional purchase amount that includes at least one of the vendor-defined prices, and in response to each conditional purchase request, executing an authorize-only credit or debit transaction using credit or debit account information from the buyer, wherein the authorize-only credit or debit transaction conditionally binds the buyer to make a purchase associated with the at least one of the content, event, product or service only upon the satisfaction of the pre-defined criteria; and
upon the satisfaction of the pre-defined criteria, automatically charging a credit or debit account of each buyer that made one of said conditional purchase requests and obligating the vendor to cause at least the content to be produced;
following satisfaction of the pre-defined criteria and during the production or development activities, making the content available to each buyer that made one of said conditional purchase requests; and
wherein the conditional purchase amounts specified in the conditional purchase requests include vendor-defined prices that are independent of an aggregate volume of conditional purchases made by the buyers.

31. The computer useable medium and computer readable code of claim 30 wherein a buyer has a vendor-defined period to purchase at least one of the content, event, product or service, over the network site.

32. The computer useable medium and computer readable code of claim 30 further comprising computer useable medium and computer readable code for monitoring the satisfaction of the pre-defined criteria.

33. A method for making a sale of content online wherein the content conveys information related to production or development activities for an event, product or service, the method comprising:
providing a network site accessible over a communication network from remote computers;
receiving, from a vendor of the content, pre-defined criteria that must be satisfied before the vendor is obligated to cause the content to be produced, wherein the pre-defined criteria is an aggregate threshold volume of conditional purchases that must be made by a plurality of different buyers for at least one of the content, event, product or service; the vendor having an option to agree to cause the content to be produced even though the pre-defined criteria have not been satisfied;
displaying commercial terms relating to making a conditional purchase for at least the content, event, product or service to the buyers over the network site, wherein the commercial terms include one or more vendor-defined prices associated with the conditional purchase;
identifying the content to the buyers over the network site, and receiving an agreement from the vendor to make the content available to each buyer in exchange for the conditional purchase during a time period following satisfaction of the pre-defined criteria and during said production or development activities;
receiving conditional purchase requests for at least one of the content, event, product or service from the plurality of buyers over the network site, each of said conditional purchase requests including credit or debit account information from a buyer and specifying a conditional purchase amount that includes at least one of the vendor-defined prices, and in response to each conditional purchase request, executing an authorize-only credit or debit transaction using credit or debit account information from the buyer, wherein the authorize-only credit or debit transaction conditionally binds the buyer to make a purchase associated with at least one of the content, event, product or service only upon the satisfaction of the pre-defined criteria or upon the vender exercising the option; and
upon the vendor exercising the option to cause the content to be produced even though the pre-defined criteria have not been satisfied, automatically charging a credit or debit account of each buyer that made one of said conditional purchase requests and obligating the vendor to cause at least the content to be produced;
following satisfaction of the pre-defined criteria or exercise of the option, and during the production or development activities, making the content available to each buyer that made one of said conditional purchase requests; and
wherein the conditional purchase amounts specified in the conditional purchase requests include vendor-defined prices that are independent of an aggregate volume of conditional purchases made by the buyers.

34. A method for making a conditional sale of a plurality of linked content items online, wherein each of the linked content item conveys information related to production or development activities for a different event, product or service, the method comprising:
providing a network site accessible over a communication network from remote computers;
receiving, from a vendor of the plurality of linked content items, pre-defined criteria that must be satisfied before the vendor is obligated to cause a subset of the plurality of linked content items to be produced, wherein the pre-defined criteria specify buyer demand parameters that determine which, if any, of the subset of the plurality of linked content items that the vendor is obligated to cause to be produced; wherein the subset includes less than all of the plurality of linked content items;
displaying commercial terms relating to making a conditional purchase for one of the linked content items to the buyers over the network site;
identifying each of the linked content items to the buyers over the network site, and receiving an agreement from the vendor to make the subset of linked content items available to each buyer of a linked content item in the subset in exchange for the conditional purchase of a linked content item in the subset during a time period following satisfaction of the pre-defined criteria and during said production or development activities, wherein said production or development activities commence after satisfaction of the pre-defined criteria;
receiving conditional purchase requests for each of the linked content items from the plurality of buyers over the network site, each of said conditional purchase requests being associated with one of the linked content items, each of said conditional purchase requests including credit or debit account information from a buyer and specifying a conditional purchase amount, and in response to each conditional purchase request, executing an authorize-only credit or debit transaction using credit or debit account information from the buyer, wherein the authorize-only credit or debit transaction conditionally binds the buyer to make a purchase for the linked content item associated with the conditional purchase of the buyer only upon the satisfaction of the pre-defined criteria for the linked content item associated with the conditional purchase of the buyer;
upon the satisfaction of the pre-defined criteria associated with each linked content item in the subset, automatically charging a credit or debit account of each buyer that made one of said conditional purchase requests associated with each linked content item in the subset, and obligating the vendor to cause each linked content item in the subset to be produced; and
following satisfaction of the pre-defined criteria associated with each linked content item in the subset, and during the production or development activities associated with each item of linked content for which the pre-defined criteria were satisfied, making the linked content items in the subset available to each buyer that made one of said conditional purchase requests associated with each linked content item for which the pre-defined criteria were satisfied.

35. A method for conducting a fundraising event online in order to raise funds for supplying a charitable good or service to one or more beneficiaries, the method comprising:
providing a network site accessible over a communication network from remote computers;
receiving, from a sponsor of the event, pre-defined criteria corresponding to an aggregate threshold level of interest in the event;
displaying terms relating to the event to a plurality of participants over the network site, and a description of content relating to production, development or delivery of the charitable good or service to the one or more beneficiaries that the sponsor will make available to each participant in exchange for a conditional payment commitment during a time period following satisfaction of the pre-defined criteria and during production, development or delivery of the charitable good or service to the one or more beneficiaries;
receiving conditional payment commitments for the fundraising event from the plurality of participants over the network site, each of said conditional payment commitments including credit or debit account information from a participant and specifying a conditional payment commitment amount, and in response to each conditional payment commitment, executing an authorize-only credit or debit transaction using credit or debit account information from the participant, wherein the authorize-only credit or debit transaction conditionally binds the participant to make a payment associated with the event only upon the satisfaction of the pre-defined criteria, wherein the predefined criteria corresponds to an aggregate threshold amount of conditional payment commitments that must be made for the event by the plurality of different participants; and
upon the satisfaction of the pre-defined criteria, automatically charging the credit or debit accounts of the participants that made said conditional payment commitments the conditional payment commitment amounts specified in the conditional payment commitments;
following satisfaction of the pre-defined criteria and during production, development or delivery of the charitable good or service to the one or more beneficiaries, making the content relating to the development or delivery of the charitable good or service available to each participant that made a conditional payment commitment; and
wherein the conditional payment commitments amounts specified in the conditional payment commitments include amounts that are independent of an aggregate amount of conditional payment commitments made for the fundraising event.

36. The method of claim 35, wherein no goods or services are provided to the participants upon satisfaction of the pre-defined criteria.

37. A method for making a conditional sale of a novelty item associated with an event or an artistic work, the method comprising:
providing a network site accessible over a communication network from remote computers;
receiving, from a vendor of the event or artistic work, pre-defined criteria that must be satisfied before the vendor is obligated to cause the novelty item, event or artistic work to be produced, wherein the pre-defined criteria includes an aggregate threshold volume of conditional purchases that must be made by a plurality of different buyers for at least one of the novelty item, event or artistic work;
displaying commercial terms relating to making a conditional purchase for at least one of the novelty item, event or artistic work, to the buyers over the network site, wherein the commercial terms include one or more vendor-defined prices associated with the conditional purchase; identifying the novelty item to the buyers over the network site, and receiving an agreement from the vendor to provide the novelty item to each buyer in exchange for the conditional purchase upon satisfaction of the pre-defined criteria;
receiving conditional purchase requests for at least one of the novelty item, event or artistic work, from the plurality of buyers over the network site, each of said conditional purchase requests including credit or debit account information from a buyer and specifying a conditional purchase amount that includes at least one of the vendor-defined prices, and in response to each conditional purchase request, executing an authorize-only credit or debit transaction using credit or debit account information from the buyer, wherein the authorize-only credit or debit transaction conditionally binds the buyer to make a purchase associated with at least one of the novelty item, event or artistic work, only upon the satisfaction of the pre-defined criteria; and
upon the satisfaction of the pre-defined criteria, automatically charging a credit or debit account of each buyer that made one of said conditional purchase requests, and obligating the vendor to cause at least the novelty item to be produced;
following satisfaction of the pre-defined criteria, providing the novelty item to each buyer that made one of said conditional purchase requests; and
wherein the conditional purchase amounts specified in the conditional purchase requests include vendor-defined prices that are independent of an aggregate volume of conditional purchases made by the buyers.

38. The method of claim 37, wherein the novelty item is a t-shirt, and the event corresponds to a concert featured on the t-shirt.

39. The method of claim 37, where the novelty item is a t-shirt, and the artistic work is an album featured on the t-shirt.

40. The method of claim 37, where the novelty item is a hat, and the artistic work is a comic book.

41. A method for conducting a fundraising event online in order to raise funds for producing a journalistic work, the method comprising:
providing a network site accessible over a communication network from remote computers;
receiving, from a sponsor of the journalistic work, pre-defined criteria corresponding to an aggregate threshold level of interest in the journalistic work;
displaying terms relating to production or development of the journalistic work to a plurality participants over the network site, and a description of content relating to the journalistic work that the sponsor will make available to each participant in exchange for a conditional payment commitment during a time period following satisfaction of the pre-defined criteria;
receiving conditional payment commitments for the journalistic work from the plurality of participants over the network site, each of said conditional payment commitments including credit or debit account information from a participant and specifying a conditional payment commitment amount, and in response to each conditional payment commitment, executing an authorize-only credit or debit transaction using credit or debit account information from the participant, wherein the authorize-only credit or debit transaction conditionally binds the participant to make a payment associated with the journalistic work only upon the satisfaction of the pre-defined criteria, wherein the predefined criteria corresponds to an aggregate threshold amount of conditional payment commitments that must be made for the journalistic work by the plurality of different participants; and
upon the satisfaction of the pre-defined criteria, automatically charging the credit or debit accounts of the participants that made said conditional payment commitments the conditional payment commitment amounts specified in the conditional payment commitments;
following satisfaction of the pre-defined criteria, making the content relating to the journalistic work available to each participant that made a conditional payment commitment; and
wherein the conditional payment commitments amounts specified in the conditional payment commitments include amounts that are independent of an aggregate amount of conditional payment commitments made for the journalistic work.

42. The method of claim 41, wherein the content comprises updates to a news story that are provided to the participants upon satisfaction of the pre-defined criteria.

43. A method for conducting a fundraising event online in order to raise funds for at least one traveler to take a trip, the method comprising:
providing a network site accessible over a communication network from remote computers;
receiving, from the at least one traveler, pre-defined criteria corresponding to an aggregate threshold level of interest in the trip;
displaying terms relating to funding of the trip to a plurality of participants over the network site, and a description of content relating to the trip that the at least one traveler will make available to each participant in exchange for a conditional payment commitment during a time period following satisfaction of the pre-defined criteria;
receiving conditional payment commitments for the trip from the plurality of participants over the network site, each of said conditional payment commitments including credit or debit account information from a participant and specifying a conditional payment commitment amount, and in response to each conditional payment commitment, executing an authorize-only credit or debit transaction using credit or debit account information from the participant, wherein the authorize-only credit or debit transaction conditionally binds the participant to make a payment associated with the trip only upon the satisfaction of the pre-defined criteria, wherein the predefined criteria corresponds to an aggregate threshold amount of conditional payment commitments that must be made for the trip by the plurality of different participants; and
upon the satisfaction of the pre-defined criteria, automatically charging the credit or debit accounts of the participants that made said conditional payment commitments the conditional payment commitment amounts specified in the conditional payment commitments;
following satisfaction of the pre-defined criteria, making the content relating to the trip available to each participant that made a conditional payment commitment; and
wherein the conditional payment commitments amounts specified in the conditional payment commitments include amounts that are independent of an aggregate amount of conditional payment commitments made for the trip.

44. The method of claim 43, wherein the content comprises travel updates about the trip that are provided to the participants upon satisfaction of the pre-defined criteria.
